(19) United States
(12) Patent Application Publication
(10) Pub. No.: US 2009/0313627 A1
(43) Pub. Date: Dec. 17, 2009

(54) TECHNIQUE FOR PERFORMING A SYSTEM SHUTDOWN

(75) Inventor: Milind Avinash Barve, Thane (IN)

Correspondence Address: BROWDY AND NEIMARK, P.L.L.C.;624 NINTH STREET, NW, SUITE 300, WASHINGTON, DC, 20001-5303, US

(73) Assignee: ECI TELECOM LTD., PETACH-TIKVA (IL)

(21) Appl. No.: 12/307,327

(22) PCT Filed: Jun. 25, 2007
(86) PCT No.: PCT/IL07/00766

§ 371 Date: Jan. 2, 2009

(30) Foreign Application Priority Data
Jul. 3, 2006 (IL) 176685

(51) Int. Cl. G06F 9/44

(52) U.S. Cl. 718/100

(57) ABSTRACT

Technique for expediting a shutdown process in a computerized system, comprising a number of software modules MUC, a number of functional components and at least one user entity U. A user entity applies requests to a MUC and serves an access provider of the MUC for accessing the functional components. The method performs accelerated shutting down of the software module MUC, by the following steps: initiating shut down of the MUC (by a user entity U); making the MUC software module opaque so as to stop managing of the functional components; shutting down the software module MUC.

### FIELD OF THE INVENTION

The present invention relates to a technology for performing shutdown of a system (or subsystem) comprising hardware (H/W) and software (S/W) components.

### BACKGROUND OF THE INVENTION

The problem considered in the present invention is how to perform a user-initiated or a failure-initiated shutdown in a system where some components are not responsive.

To the best of the Applicant's knowledge, solutions known in the prior art do not refer to the above problem in that specific aspect. Some solutions refer to acceleration of switching ON for various systems, some of prior art solutions refer to a problem of preparing a system, which is being switched OFF, to be faster switched ON next time.

US published patent application 20060069835/US-A1 “System and method for the management of hardware triggered hotplug operations of input/output cards” describes a method of managing insertion/removal of one or more input/output (I/O) cards of a computer system. The method comprises receiving hardware triggers, each of which relates to a hotplug operation to be carried out on an I/O card associated with a card slot, placing the hardware triggers in a queue, and processing the queue of hardware triggers. The method further comprises processing one or more of said hardware triggers. This comprises analyzing a hardware trigger to determine the card slot to which said hardware trigger relates, and consulting a hotplug operation policy to determine whether hotplug operations are enabled for said card slot. Thereupon, if said hotplug operation is a delete card hotplug operation or a suspend card hotplug operation, this further comprises determining whether said card is essential or non-essential to said computer system, and ignoring said delete card hotplug operation or said suspend card hotplug operation when said card is essential, and performing said delete card hotplug operation or said suspend card hotplug operation when said card is non-essential. If said hotplug operation is an add card hotplug operation or a resume card hotplug operation, this further comprises performing said add card hotplug operation or said resume card hotplug operation.

However, the US 20060069835 does not discuss any optimization techniques that may be used to implement the described steps in an efficient manner.

US published patent application 20040199696/US-A1 describes a computer software system for facilitating a user's replacement or insertion of devices in a computer server network system. The system allows a user to swap or add peripheral devices while the system is running, or in a “hot” condition, with little or no user knowledge of how the system carries out the “hot swap” or “hot add” functions. The system, which consists of a graphical user interface (GUI) and associated computer software modules, allows the user to select a desired peripheral device location within a server, and then provides the modular software structure to automatically execute a series of steps in the hot swap or hot add process. Each step is prompted by the user from the GUI, to invoke commands to instruct a network server through its operating system and hardware to suspend the appropriate device adapters, if necessary, power down the desired device slot or canister, allow the user to replace or insert a new device, and finally restart the adapters and the slot power.

Still, the 20040199696/US-A1 requires the user interaction, and does not refer to any optimization of the operation of removal of a prior component from the system.

U.S. Pat. No. 6,731,832 discloses an optical switch architecture in an optical communications network. The imminent removal of a line card from a slot at the optical switch is detected to inform an associated software process/manager that manages the line card that it is going to be removed. The movement of a locking mechanism that locks the line card in its slot triggers a message to a Node Manager that the line card is about to be removed. The software process knows that it will not be able to communicate with the line card, such as to request data or transmit commands. Moreover, the software process knows to not set an alarm for a malfunctioning line card since it will not receive any responses from the removed line card. The software process also maintains information related to the line card during its removal for use when the line card is subsequently re-installed. The goal of the solution of U.S. Pat. No. 6,731,832 is exploiting available information about an ongoing swap-out (removal) of some hardware component, for a purpose of “state preservation & restoration” for later swap-in of the same card. No attempts of optimizing the swap-out process are described.

U.S. Pat. No. 6,105,089 describes a data management system that supports hot plug operations on a computer by defining, organizing, and maintaining hot plug variables, stored on a computer readable medium, which identify components of a computer that may be involved in hot plug operations, and which also identify capabilities and operational states of those components as well as control their operation and interface to the computer. The hot plug variables identify a component as well as represent states and capabilities of a component, and thus the hot plug variables operate as commands to predetermined components of a computer which support hot plug operations on the computer. The system generally comprises a plurality of variables to support adding a component to or exchanging components of a computer while the computer runs, as well as hot plug variable data stored in a computer readable medium, the hot plug variable data representing capabilities, characteristics or states of components of the computer, the hot plug variable data related to the plurality of variables. Also the U.S. Pat. No. 6,105,089 does not refer to optimizing the swap-out process.

One specific class of computerized systems can be described by a generalized model shown in FIG. 1. A user entity U marked 10 which can be understood as a human (human-user interface), a machine based access provider, a manager software running on behalf of other user entity, a management system or the like, controls the life cycle of a software module called MUC (Module Under Consideration, marked 12) in a system 18. U (10) is the sole access provider of MUC (12). The vertical line 13 near U 10 symbolizes the line of demarcation in a higher level hierarchical system (not marked) that includes the system 18 as its sub-system; the meaning of line 13 is that rest of the modules requiring the services of MUC 12 necessarily have to contact the user entity U (10) as they do not directly make requests/send commands to the MUC 12. MUC 12 is initially designed such that it can be removed or urgently shut down while the system is functioning. The User entity U 10 has extended knowledge about a set of other functional system components: hardware modules Fi (one of them is marked 14), and optional operational modules Oj (one of them marked 16 e.g., memory blocks, software objects), where 1≦i≦N, 1≦j≦M, and where i, j, N, M are integers. Suppose a sub-system 19 comprising at least the illustrated MUC 12 is being urgently shut down for some reason, and that at least one of the Fi-s (14) has either failed or is being removed as a part of the sub-system shutdown. In other words, such a malfunction of the Fi(−)s is not necessarily the reason of the urgent shutdown but the thing which—if happens—is supposed to drastically complicate the shutdown process.

The entire system as a whole continues to operate while one or more of its components (for example, sub-systems like 18) are being shutdown.

We keep in mind that U (10) is the sole access provider of MUC (12) to the rest of the system in this model and therefore is responsible for appropriately handling all requests received from other modules during the shutdown phase. During normal operation, the MUC 12 receives a set of requests (for example, requested software operations) from U 10 to provide certain functionality. In turn, the MUC 12 needs to operate on various Fi and Oj modules 14, 16 in order to complete these operations. In order to provide the requested functionality, the MUC 12 usually reserves resources in the Fi, Oj modules, which resources need to be freed up when the functionality is no longer needed by the U 10.

Let the MUC 12 is being urgently unplugged. During the shutdown phase when, say, one Fi 14 has failed and/or no longer accessible/responsive, or just not guaranteed to be accessible throughout the shutdown process, the MUC could not possibly “unwind” it as a part of its resource cleanup. During the shutdown phase, the user entity U 10 explicitly informs MUC 12 about all Fi modules 14 and requires to clean up part of its world—say, resources in the Oj modules 16. It should be noted that lifecycles of Oj objects (which are typically system resources such as memory blocks) may span multiple incarnations of the MUC 12. It is therefore assumed that the MUC 12 will not be expected to provide its normal functionality during this shutdown phase, it is only expected to free its resources; however, even this procedure may be retarded by the described circumstances.

As has been mentioned in the above general example, shutdown of such a system 18 may be either user initiated, or triggered by some failure event in the system or beyond it. Moreover, during the shutdown, some parts of the system (software components and/or the underlying hardware) may appear not responsive, and that happens quite often. It therefore adds little value to the shutdown process by attempting to un-program these blocks of the system when it is known in advance that such operations may not succeed.

### OBJECT AND SUMMARY OF THE INVENTION

It is an object of the present invention to improve management of processes of dynamic changes in configuration of a computerized system (say, a computer system or a modern telecommunication system), and more specifically—to optimize the process of shutting down (hot-swapping, unplugging) components of such a system.

The Inventor has realized that for the class of computerized systems, which has been described in the Background section with reference to FIG. 1, the shutdown process can be rationalized.

The above objective can be achieved by providing a method for expediting a shutdown process in a computerized system comprising the following components: at least one software module (called, for example, module under consideration MUC), a number of functional components and at least one user entity U, capable of applying requests to said at least one MUC and serving an access provider of said at least one MUC to access and communicate with the functional components of the system, wherein said functional components comprising at least one hardware component (called Fi) being controlled by said at least one MUC for performing requests of said at least one U;

the method being characterized in that it comprises a step of accelerated shut down (so-called hot-swapping or urgent unplugging) of said at least one software module MUC, by performing the following sub-steps:

A) initiating, by a particular user entity U, shut down of a specific software module MUC among said at least one software modules MUC,

B) making the specific software module MUC opaque, thereby to stop managing said functional components,

C) shutting down said specific software module MUC.

The proposed solution deals with the existing system software modules (or software objects, if the Object Oriented programming is used), instead of trying to implement any additional failure handling logic on a failure-case and software design specific basis as it was usually done in the prior art. The proposed solution requires minimal changes to the existing code base and ensures significant run-time savings.

In the frame of the present description, the term “opaque” should be understood as the state of MUC becoming invisible, inaccessible and/or unresponsive for any components of the system or beyond it.

Those skilled in the art may illustrate the term “opaque” by a number of examples. The opaque software module stops “demonstrating” its parameters/features to other system components, thus becoming “invisible”. In some cases, calls made by rest of the world on the user entity U will not be forwarded to MUC in which case the MUC has become opaque (“inaccessible”) as it can't be reached even indirectly (through U) by the outside world. In other cases, U may forward the calls made by external world to MUC but, since MUC is being shut down (unplugged), MUC may return invalid results without actually performing any action. It will thus become opaque (“unresponsive”) to external world's requests.

It is understood, that sub-step A intrinsically comprises preliminary establishing, by the particular user entity U, a need for a required shut down and consequently, a necessity of unplugging the specific software module MUC.

The mentioned necessity can be caused by detecting at least one event selected from the following non-exhaustive list: user initiated maintenance or upgrade, failure in the system or beyond it (for example, in another system associated with the discussed system), unplugging (swapping out) of one or more functional components of the system.

In the above-proposed method, the combination of the sub-step B preceded by the sub-step A actually forms a novel and effective solution of the shut down problem in the system. Using the claimed combination, the method allows to leverage the knowledge being resident in the higher level entity U: since U knows that something relevant to functionality of a particular MUC has failed or is being swapped out (see the incomplete list above) such, that during step A the MUC is asked to enter the urgent shut down “swap-out” phase. Consequently, the MUC becomes ‘opaque’ and performs sub-step B.

In practice, the sub-step B comprises performing at least one (or preferably, all) of the following operations after the step (A) of shut down or unplugging is initiated:
1) stopping requests made by the particular U to said specific software module MUC and/or ignoring, by said specific software module MUC, requests made by said particular U and/or said functional components to said specific software module MUC,
2) disregarding, by said specific software module MUC, internal information concerning status of previous requests made:
   2a) by any of said at least one U and/or said functional components to said specific software module MUC, and/or
   2b) by said specific software module MUC to any of said at least one hardware components Fi.

Actually, the process comprises shutdown of the functional components of the computerized system by stopping managing these functional components, and by shutting down the software modules corresponding to said functional components.

In software terms, step B and, in particular, operation 1 comprise returning the requests (e.g., software calls/operations, commands, communication calls), if applied to the MUC, without performing any action, consequently the data returned by these calls may not be valid. As has been mentioned above, the MUC essentially becomes opaque/unresponsive to all its users since/while it starts “unplugging” itself.

The method may further comprise a step of shutting down (“unplugging”) said particular user entity U together with shutting down said specific software module MUC.

In many cases, the functional components of the system comprise at least one operational module (let it be called Oj, such as memory); in these cases, the shut down process usually comprises a step of freeing resources previously created in said at least one Oj by any specific software module MUC which is presently being unplugged.

To clarify the above statement, it should be explained that during the normal operation, MUC may have maintained software states for the requests (calls) it initiated on Fi & Oj. The MUC cam disregard the states it has maintained for all Fi functional modules and only use the ones pertaining to Oj-s functional/operational modules, but free all the resources in the Oj-s. It has been already mentioned, that MUC may also ignore internal states of its variables for the requests (calls) made on it by the user entity U since the MUC is no longer responsible for providing any functionality to its users.

We keep in mind that when implementing the method, at least one of the Fi-s of the system appear non-responsive quite often. The non-responsive Fi should be understood as Fi being either failed, becoming inaccessible, or being removed—sometimes as a part of the shutdown process. It should be noted that shut down of the system may be caused by various reasons: maintenance (usually, user initiated), upgrades, failure in some part of the system or any system associated with said system, etc.

However, in any case the proposed method expedites the shutdown process, since it prevents useless attempts to access hardware components. In other words, even if the hardware components were all responsive, it would take longer time to shut them down without the proposed approach. Therefore it makes sense to adopt the proposed shutdown strategy in computerized systems in advance, without referring to state of the underlying hardware.

The Inventor investigated behavior of the described class of systems (model of FIG. 1) and noted a number of cases where the hardware component on a card responds for a while as the card that is being shutdown is being pulled slowly out of it's position. Once the card looses certain critical contacts and signals with the system, the hardware becomes unresponsive. The hardware behavior can be even more erratic (works-fails-works) when there is an internal hardware error. Such situations are also treatable by the proposed method of accelerated shut down.

In the preferred version of the method, the software in the system is implemented using C++ programming language and Object Oriented (OO) programming technology. According to that technology and terminology, an Object means a software component (a piece of program logic associated with some state information, created, allocated and initialized in the memory). On the other hand a Device/Board implies a real piece of hardware. Typically Objects and Devices go together: an Object is created to control the underlying Device. For example, we have a PHY (Physical Layer Interface) module object that controls/manages the entire PHY module (PHY card or board). Similarly we may have chip driver objects for each of the chips (aka chip-devices). During PHY-hotswap, we shutdown (stop-managing) all PHY devices, shut down (“destroy” in the widely used OOP terminology) all the corresponding objects and subsequently recreate these objects during the Swap-in (hardware re-initialization) phase. A module refers to a collection of objects either physical or logical. For example, PHY module object implies that it is a logical (software) object that manages the entire PHY board. Where as PHY board/PHY module board or simply PHY module implies the physical PHY board mechanically attached to the physical NPB board.

For the case of object oriented programming technology, such as CORBA, the method may additionally comprise a step of unregistering various software objects (such as managed interfaces and elements) to guarantee that the software module and its constituents to be shut down (say, object of Fi, MUC and its U) become invisible to the external world.

Optionally, the method may comprise a step of disconnecting various software objects to be destroyed (for example, software object of Fi, MUC) from internal threads (such as protocol timers and Data Manager). Also optionally, the objects such as MUC are better to be prevented from accessing other MUC-s or other U-s (as well as other components of the system) by stopping their internal threads.

Further, the method may comprise initiating the shut down (destroying, “unplug”) on additional MUCs of the system, in case such MUCs exist and in case their shut down is essential.

For implementing the step (1) in the above-defined method, in case the OO programming is utilized, interface objects such as Application Program Interfaces (API) are being destroyed. Destroying of the software objects responsible for interfacing between the U and MUC ensure that U and MUC cannot validly communicate with one another.

Upon destroying the interface, objects, the software objects of various layers are also destroyed (i.e., a specific operation is invoked to remove previously created OO objects). Finally and usually, the U software object is also destroyed.

According to a second aspect of the invention, there is also proposed a computerized system capable of performing accelerated shut down and comprising the following components: at least one software module under consideration MUC, a number of functional components, a user entity U being at least partially software entity and capable of applying requests to said at least one MUC and serving an access provider of said at least one MUC to access and communicate with the functional components of the system, wherein said functional components comprising at least one hardware component Fi being utilized by said at least one MUC for performing requests of said U;

the system further comprising a software control means being capable of accelerating shut down of said at least one software module MUC by causing at least one of the following actions upon said user entity U initiates shut down of a specific software module MUC:
making the specific software module MUC opaque, thereby to stop managing said functional components,
shutting down (for example, destroying) said specific software module MUC.

As has been mentioned with respect to the method, the action of making the MUC opaque is preferably implemented by:

stopping requests made by the user entity U to said specific software module MUC
ignoring, by said specific software module MUC, requests made by said U and/or said functional components to said specific software module MUC,

disregarding, by said specific software module MUC, internal information concerning status of previous requests made:

a. by said U and/or said functional components to said specific software module MUC, and/or

b. by said specific software module MUC to any of said at least one hardware components Fi.

Optionally, the software control means is capable of initiating and performing shut down of the U.

Preferably, the software control means is a dedicated software component installed in the system that manages a number of MUCs including said specific software module MUC. In another example, the software control means can be part of a CPU (central processing unit) running software libraries of the system and managing multiple MUCs simultaneously. For example, the CPU can be implemented on the ST50 series.

The system should be capable of collecting information and timely informing the user entity U about the need for shutdown, for example, in case of detecting at least one event selected from the following non-exhaustive list: maintenance or upgrade (usually, user initiated), failure in the system or in a system associated there-with, unplugging of at least one of the system components. The software control means may participate in performing that task.

The mentioned computerized system is preferably an embedded computing system that supports hot-plug, hot swap and the partial shutdown features. In a specific case, such a system may be used in telecommunication systems.

According to a third aspect of the invention, there is provided a software product (actually, the mentioned software control means as a product) comprising computer implementable software instructions and/or data which, being run on a computer, allow carrying out the method according to the invention.

Further, there is also provided a computer readable medium where said computer implementable software instructions and/or data are stored.

The invention will be explained in detail as the description proceeds.

### BRIEF DESCRIPTION OF THE DRAWINGS

The invention will be further described and illustrated with reference to the attached non-limiting drawings, in which:

FIG. 1 illustrates a generalized model of the computerized system for which the inventive technique of shutdown acceleration is hereby proposed.

FIG. 2 illustrates one practical exemplary embodiment of the generalized model shown in FIG. 1.

FIG. 3 illustrates a physical component and interconnection model for the software/hardware embodiment shown in FIG. 2.

### DETAILED DESCRIPTION OF PREFERRED EMBODIMENTS

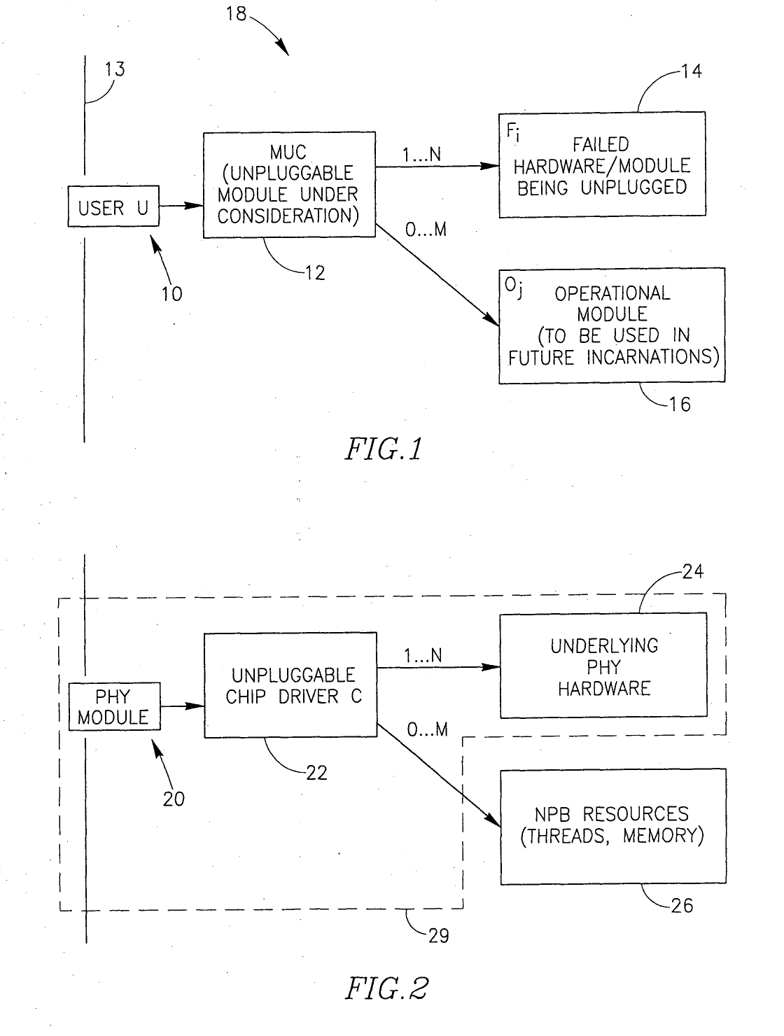

FIG. 1 has been discussed in the Background description.

FIG. 2 illustrates a specific example of the discussed model of a computerized system, in this example the software modules/portions/objects are created for controlling underlying hardware by using a widely known Object Oriented (OO) programming technology.

The user entity U in this example is a PHY (Physical Layer Network

Interface) module comprising both a hardware portion and a software object 20 that controls an individual PHY chip driver software object 22. Typically, a PHY module object 20 controls several chip driver objects, but we limit our example to just one object 22 for the sake of simplicity. The PHY module is an embedded software module within the system that is indicated by the dotted box 29. Hierarchically, the PHY module 20 is the sole access provider of the chip driver 22, as it was stated in the generalized model of FIG. 1.

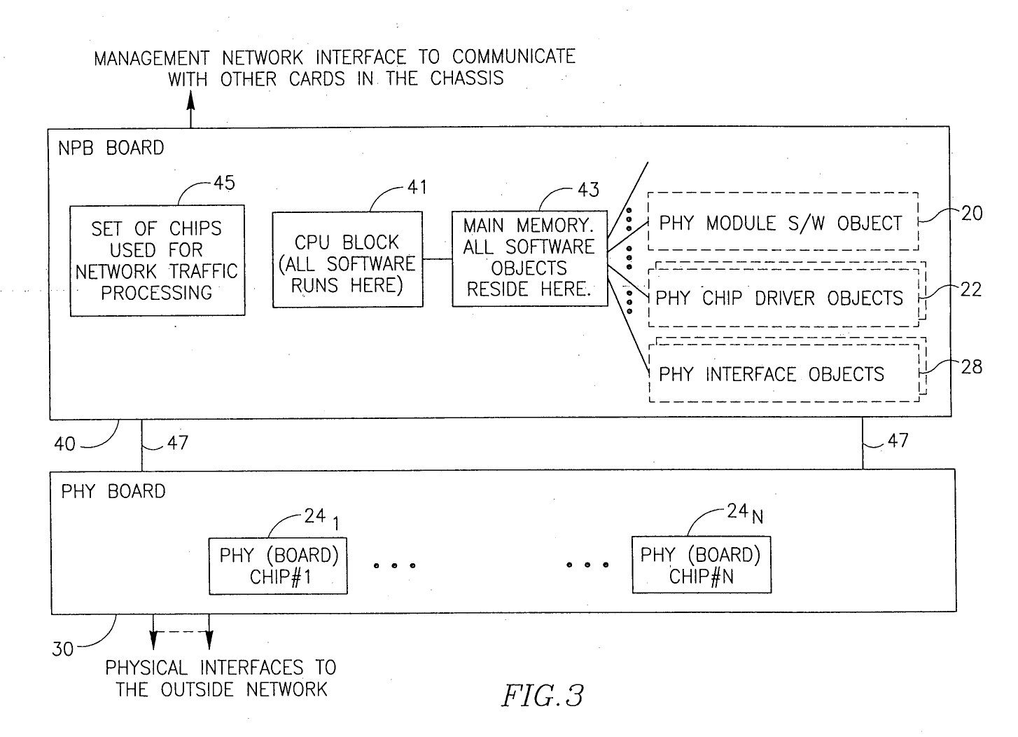

While FIG. 2 is a logical representation of the involved software components in one specific case, FIG. 3 depicts the physical interconnection of various components in the specific case shown in FIG. 2. It will be convenient to refer to both these pictures in parallel. Telecommunication equipment for switching or routing in Layer 2 or Layer 3 networks may use multiple NPBs (Network Processing Blades) in a single chassis. Traffic can be aggregated into a box using PHY (Physical Layer Interface) hardware cards or boards. A single NPB 40 may be attached to one or more PHY cards. One PHY hardware card/board 30 is shown in FIG. 3. It is the PHY module object (U, 20) that “glues” NPB and PHY worlds together.

Customers can swap out a PHY card 30 while the system is operational and replace it with another PHY card of the same or different kind. In order to maintain the integrity of the system, the control processor CPU 41 (present on the corresponding NPB card 40) has to take certain steps upon detecting the swap-out event. These steps include unprogramming various hardware & software parameters located on the NPB and destroying software objects (such as 22, 28, 20) created initially at the NPB's control processor CPU 41 to control the PHY hardware (such as Fi 24, etc.). It is this later step that the proposed solution tries to speed up. All the software objects in the specific discussed implementation reside on the NPB board 40, which is the one that has a single CPU 41 and a memory 43 associated with it. All the software objects (schematically shown using dotted boxes 20, 22, 28) reside at the memory 43; all the software logic executes on the CPU 41. NPB board 40 is an aggregation of the mentioned control CPU, memory and also packet processing chips 45 that receive/send packets from/to physical interfaces located on PHY that are attached to the external network.

The PHY board 30 does not have a CPU and it gets controlled by the software objects (such as 20, 22, 28) located on NPB's CPU. Thus some of the software objects either control the PHY board or chips on the PHY board that is physically attached to the NPB board through a mechanical connector 47 carrying electrical signals. In our specific model (FIG. 2), U 10 corresponds to the PHY board's 30 object 20, while there are several MUCs 12 (chip drivers 22), each for one chip (24₁ . . . 24_{N}) on the PHY board 30. Therefore in our specific implementation, the PHY object is U, which is the sole access provider of various PHY MUCs 22 to reset of their software objects resident on the NPB. The U object 20 in our case is swapped-out (or destroyed) after all the MUCs 22 are destroyed.

Let us now return to the description of FIG. 2.

The PHY module hotswap can be initiated in response to a physical PHY swap out, removal/shutdown of the underlying PHY hardware, or in response to the user initiated PHY reset (for example, reset of all the blocks enclosed by a dotted region 29. When we say “PHY module” is hot swapped, we mean that, according to a shut-down instruction or swap-out event (say, detected by CPU), the whole PHY-board is to be shut down and that all its corresponding software parts (20, 22 etc.) are thus to be destroyed.

The PHY hardware is assumed to be inaccessible during this phase (unless the PHY card is being swapped out slowly). A proprietary software being one of the aspects of protection of the invention, runs on a control processor CPU 41, which is located physically on the NPB board 40, and initiates destruction of various software objects, corresponding to the PHY and indicated by a dotted region which includes the PHY module object 20 and various chip driver MUC objects 22, as a part of its swap-out process. Actually, all the software objects corresponding to the hot-swapped PHY card with the underlying hardware (PHY module object 20, chip drivers objects 22, PHY interface stacks and their NPB software counterparts 28) need to be destroyed.

The PHY Interface stacks are other software objects located at the same NPB's CPU that “map” to physical interfaces on the PHY board. Since the PHY is vanishing, these interface objects need to go as well. When the PHY module 20 initially receives the hotswap indication (say, from CPU 41), it destroys its components. PHY module object 20 manages the PHY board 30 as a whole, including chip driver objects 22 that manage individual chips 24₁ . . . 24_{N} located on the PHY board 30. Since the PHY module in our example creates and owns various interface object stacks (according to the hierarchy, the PHY module components are PHY module object 20, PHY chip driver object 22, PHY interface objects 28), it starts destroying these objects hierarchically, which includes un-programming various NPB and PHY hardware components. Finally, the PHY module gets destroyed itself by a hotswap handler of the proprietary software (not shown), also residing in the CPU 41-Memory 43.

Conventionally (i.e., without using the proposed invention), the PHY software object cleanup usually involves:
I. changing states of software variables that reflect the underlying PHY hardware
II. attempting to unprogram the PHY hardware (which is usually not accessible)
III. freeing system resources (memory from the NPB's CPU & timers)

Let the PHY module object at this point knows that the PHY hardware is not accessible and therefore only needs to worry about “unwinding” the NPB hardware and destroying various software objects. It has been checked and shown by the Inventors, that a considerable amount of time would be spent by the chip driver C (shown as 22 in FIG. 2) if it were to attempt “unwinding” the PHY hardware 24 that is no longer accessible. According to the inventive technique, it is proposed to make use of the knowledge available to the PHY module 20 in order to prevent various PHY chip drivers from making such futile attempts that impact overall system performance. In the proposed solution, the PHY module 20 indicates various PHY chip objects (such as chip drivers 22) to unplug themselves in an expeditious manner. Once a chip driver receives unplug indication, it assumes that the external world is no longer going to need its functionality. It then only worries about releasing NPB/Operating System specific resources that need to be conserved across PHY hotswaps and does not attempt talking to the underlying PHY hardware (chip, Fi, 24). The PHY chip drivers 22 do not make direct calls (requests) on NPB software or hardware objects in the described model, according to the proposed method of the PHY module shutting down. The PHY module 20 continues cleaning interface stacks it created, which in turn is expected to un-program the NPB hardware.

The PHY module object 20 avoids using any functionality from chip drivers 22 that are being unplugged. I.e., PHY module “should” not call on chip drivers while it is being destroyed. If such a call is made, the chip driver (MUC) is free to ignore it and not provide a valid response.

Therefore, the inventive proposal is actually to skip steps I and II of the conventional method altogether, and “simply” implement step III (i.e., allow it to be directly implemented). This solution can be implemented incrementally in an existing software codebase, and that is another important advantage of the proposed solution.

The specific example shown in FIGS. 2 and 3 can be best implemented using the OO programming technology, for example CORBA. The following sequence of steps can be taken by the PHY module during swap-out.

1. Unregister various CORBA objects (managed interfaces & elements) to guarantee that the PHY module and its constituents become invisible to the external world. (CORBA (un)registration is a software operation where software objects interact with a global CORBA object that facilitates communication between entities located on NPB's management network: for example between two NPBs located inside a hardware chassis.)
2. Disconnect various software objects from internal threads, if such exist (such as protocol timers & the Data Manager). For example, we may stop/disconnect all running threads that could operate on the software objects that are being destroyed. At this point in the implementation, we disconnect all threads operating on interface objects and PHY module. The next step requires stopping the threads that are internal to MUCs (chip driver objects).

In the OO (Object Oriented) module, each software object is comprised of data and program instructions. Additionally it may contain a CPU execution context, which is alternatively called as “threads” in an operating system context.

3. Instruct the chip drivers to stop their internal threads (if any) from accessing other PHY chips/PHY modules. This is an optional step. (A MUC should stop accessing other MUC's, the PHY module U and Fis which are not guaranteed to be responsive any way. A MUC is required to talk to Ojs but only with the limited goal of freeing the resources in Ojs that it reserved previously, during the normal operation.)
4. Initiate “unplug” on various PHY chip objects. It is a software operation implying a PHY chip object (software), however since PHY chip objects provide a mechanism to access the physical chips on the PHY board, preventing the former also prevents access to the physical chip. The approach can be applied to a conventional system with various software objects in a phased manner, and the benefits of the approach can be incrementally measured.
5. Start destroying interface object stack. The time saving is mostly realized in this phase. The PHY module should either not invoke any PHY chip Application Program Interface API not to communicate with chip driver (MUC) or should be prepared to deal with invalid returned data from chip drivers. In the discussed implementation, it is the chip driver APIs that silently return without performing any operation once these are in the “unplug” phase.
6. After destroying interface stack, the PHY module destroys chip objects. It is assumed that the chip objects have released all the NPB resources by this point and will release any left over resources (such as memory) as part of their class destructors.
7. The hotswap handler (residing in the software control means) destroys the PHY module object (U).

The proposed solution was implemented and benchmarked on a 4 port channelized ST200 OC-3 card. Swap out times with and without the proposed solution for a configuration containing 216 links (54 per port) and 24 multi-link bundles (6 per port) were compared. The swap out took approximately 4 seconds with the proposed solution as opposed to 253 seconds with the conventional implementation.

Further analysis of the results suggests that without the proposed solution, most of the time is spent generating and handling C++ exceptions that are thrown as various PHY chip drivers attempt to access hardware. Such exceptions could also lead to secondary failures in the chip drivers during subsequent “cleanup” operations. All of these are avoided mainly by not executing any driver calls in the proposed solution.

1-17. (canceled)

18. A method for expediting a shutdown process in a computerized system comprising the following components: at least one software module MUC, a number of functional components and at least one user entity U, capable of applying requests to said at least one MUC and serving an access provider of said at least one MUC to access the functional components of the system, wherein said functional components comprising at least one hardware component Fi manageable by said at least one MUC for performing requests of said at least one user entity U, the method comprising a step of accelerated shutting down of said at least one software module MUC, by performing the following sub-steps:
A) initiating, by a particular user entity U, shut down of a specific software module MUC among said at least one software modules,
B) making the specific software module MUC opaque, thereby to stop managing said functional components, and
C) shutting down said specific software module MUC.

19. The method according to claim 18, wherein the sub-step A) comprises preliminary establishing, by the particular user entity U, a need for shut down of the system due to at least one event selected from the following non-exhaustive list: maintenance or upgrade actions, failure in said system or another system associated therewith, unplugging of one or more functional components of said system.

20. The method according to claim 18, wherein the sub-step B) comprises performing at least one of the following operations after the shut down is initiated:
1) stopping requests made by the particular U to said specific software module MUC and/or ignoring, by said specific software module MUC, requests made by said particular U and/or said functional components to said specific software module MUC,
2) disregarding, by said specific software module MUC, internal information concerning status of previous requests made:
2a) by any of said at least one U and/or said functional components to said specific software module MUC, and/or
2b) by said specific software module MUC to any of said at least one hardware components Fi.

21. The method according to claim 18, further comprising a step of shutting down said particular user entity U.

22. The method according to claim 18, wherein the functional components of the system comprise at least one operational module Oj, said method further comprising a step of freeing resources previously created in said at least one Oj by said specific software module MUC.

23. The method according to claim 18, wherein software in the system is implemented using C++ programming language and Object Oriented (OO) programming technology, by creating a hierarchy of software objects for managing a hierarchy of physical devices, and wherein the method further comprises at least one of the following additional steps:
unregistering software objects to be shut down;
disconnecting software objects to be shut down from their internal threads, for implementing the operation 2; and
shutting down software objects, previously created for interfacing between U, MUC and Fi, for implementing the operation 1.

24. A computerized system capable of performing accelerated shut down comprising:
at least one software module under consideration MUC,
a number of functional components,
a user entity U capable of applying requests to said at least one MUC and serving an access provider of said at least one MUC to access the functional components of the system,
wherein said functional components comprising at least one hardware component Fi manageable by said at least one MUC for performing requests of said U,
the system further comprising a software control means capable of accelerating shut down of said at least one software module MUC by causing at least one of the following actions whenever urgent shut down of said specific software module MUC is initiated by the user entity U:
making the specific software module MUC opaque, thereby to stop managing said functional components, and
shutting down said specific software module MUC.

25. The system according to claim 24, wherein the user entity U is capable of initiating urgent shut down of said MUC based on establishing a need for the system shut down in case at least one event selected from the following non-exhaustive list is detected:
maintenance or upgrade actions,
failure in said system or another system associated therewith, and
unplugging of one or more functional components of the system.

26. The system according to claim 24, wherein the software control means is operative to make the MUC opaque by:
stopping requests made by the user entity U to said specific software module MUC
ignoring, by said specific software module MUC, requests made by said U and/or said functional components to said specific software module MUC,
disregarding, by said specific software module MUC, internal information concerning status of previous requests made:
a. by said U and/or said functional components to said specific software module MUC, and/or
b. by said specific software module MUC to any of said at least one hardware components Fi.

27. The system according to claim 24, wherein the software control means is capable of initiating and performing shut down of the user entity U.

28. A software product comprising computer implementable software instructions and/or data for carrying out the method according to claim 18, stored on an appropriate computer readable storage medium so that the software is capable of enabling operations of said method when being run on a computer.
